(19) United States
(12) Patent Application Publication
(10) Pub. No.: US 2025/0039597 A1
(43) Pub. Date: Jan. 30, 2025

(54) ACOUSTIC OUTPUT DEVICES

(71) Applicant: SHENZHEN SHOKZ CO., LTD., Shenzhen (CN)

(72) Inventors: Guangyuan ZHU, Shenzhen (CN); Lei ZHANG, Shenzhen (CN); Junjiang FU, Shenzhen (CN); Xin QI, Shenzhen (CN)

(73) Assignee: SHENZHEN SHOKZ CO., LTD., Shenzhen (CN)

(21) Appl. No.: 18/914,242

(22) Filed: Oct. 13, 2024

Related U.S. Application Data
(63) Continuation of application No. PCT/CN2022/140959, filed on Dec. 22, 2022.

(51) Int. Cl. H04R 1/24; H04R 3/12; H04R 9/02; H04R 9/04; H04R 17/10

(52) U.S. Cl. CPC H04R 1/24; H04R 3/12; H04R 9/025; H04R 9/045; H04R 17/10; H04R 2460/13

(57) ABSTRACT

Embodiments of the present disclosure provide an acoustic output device comprising a bone conduction sound generation unit and a piezoelectric sound generation unit. The bone conduction sound generation unit is configured to generate bone conduction sound waves that are transmitted to human ears via bone and have at least one resonance peak in a frequency range not higher than 1 kHz. The piezoelectric sound generation unit is configured to generate sound waves that have at least one resonance peak in a range not lower than 6 kHz.

### CROSS-REFERENCE TO RELATED APPLICATIONS

This application is a Continuation of International Patent Application No. PCT/CN2022/140959, filed on Dec. 22, 2022, the entire contents of which are incorporated herein by reference.

### TECHNICAL FIELD

The present disclosure relates to the field of acoustics, and in particular, to acoustic output devices.

### BACKGROUND

Sound output has low, medium, and high frequencies. The high-frequency output of existing acoustic output devices is generally insufficient, affecting their sound quality performance. Particularly, in the field of bone conduction acoustics, bone conduction has a great attenuation on high-frequency sound transmission, and there is a more urgent need for high-frequency output enhancement.

Therefore, it is desired to provide an acoustic output device with improved high-frequency sound output.

### SUMMARY

One of the embodiments of the present disclosure provides an acoustic output device comprising a bone conduction sound generation unit configured to generate bone conduction sound waves that are transmitted to human ears via bone and that have at least one resonance peak in a frequency range not higher than 1 kHz; and a piezoelectric sound generation unit configured to generate sound waves that have at least one resonance peak in a range not lower than 6 kHz.

### BRIEF DESCRIPTION OF THE DRAWINGS

FIG. 1 is a block diagram illustrating an acoustic output device according to some embodiments of the present disclosure;

FIG. 2 is a graph illustrating frequency response curves of a bone conduction sound generation unit, a piezoelectric sound generation unit, and a combination thereof, according to some embodiments of the present disclosure;

FIG. 3A is a schematic diagram illustrating an exemplary structure of an acoustic output device according to some embodiments of the present disclosure;

FIG. 3B is a schematic diagram illustrating an exemplary structure of an acoustic output device according to some other embodiments of the present disclosure;

FIG. 4 is a schematic diagram illustrating an exemplary structure of a piezoelectric sound generation unit according to some embodiments of the present disclosure;

FIG. 5 is a schematic diagram illustrating an exemplary structure of a piezoelectric sound generation unit according to some embodiments of the present disclosure;

FIG. 6A is a schematic diagram illustrating an exemplary structure of an acoustic output device according to some embodiments of the present disclosure;

FIG. 6B is a schematic diagram illustrating an exemplary structure of another acoustic output device according to some more embodiments of the present disclosure;

FIG. 7A is a schematic diagram illustrating an exemplary structure of an acoustic output device according to some embodiments of the present disclosure;

FIG. 7B is a schematic diagram illustrating an exemplary structure of an acoustic output device according to some embodiments of the present disclosure;

FIG. 8A is a schematic diagram illustrating an exemplary structure of another acoustic output device according to some embodiments of the present disclosure;

FIG. 8B is a schematic diagram illustrating an exemplary structure of a bone conduction sound generation unit according to some embodiments of the present disclosure; and

FIG. 9 is a schematic diagram illustrating an exemplary structure of yet another acoustic output device shown according to some embodiments of the present disclosure.

### DETAILED DESCRIPTION

To more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that “system,” “device” “unit,” and/or “module” as used herein is a manner used to distinguish different components, elements, parts, sections, or assemblies at different levels. However, if other words serve the same purpose, the words may be replaced by other expressions.

As shown in the present disclosure and claims, the words “one,” “a,” “a kind,” and/or “the” are not especially singular but may include the plural unless the context expressly suggests otherwise. In general, the terms “comprise,” “comprises,” “comprising,” “include,” “includes,” and/or “including,” merely prompt to include operations and elements that have been clearly identified, and these operations and elements do not constitute an exclusive listing. The methods or devices may also include other operations or elements.

Embodiments of the present disclosure provide an acoustic output device. In some embodiments, the acoustic output device may include a bone conduction sound generation unit and a piezoelectric sound generation unit. The bone conduction sound generation unit may generate bone conduction sound waves that have at least one resonance peak in a frequency range not higher than 1 kHz, and the piezoelectric sound generation unit may generate sound waves that have at least one resonance peak. Specifically, the bone conduction sound generation unit outputs mid-frequency sound waves, and the piezoelectric sound generation unit outputs high-frequency sound waves by utilizing its characteristics (e.g., an intrinsic frequency of a piezoelectric member included in the piezoelectric sound generation unit). Both the bone conduction sound generation unit and the piezoelectric sound generation unit are complementary to each other and mutually compatible, which may ensure that the acoustic output device has a better sound output effect at a high frequency. Thus, a user may receive a relatively large listening volume in a high-frequency band when wearing the acoustic output device. In some embodiments, the piezoelectric sound generation unit and the bone conduction sound generation unit may be provided on a side of a housing of the acoustic output device that contacts a human face, and the piezoelectric sound generation unit and the bone conduction sound generation unit generate bone conduction sound waves that are transmitted via the bone to the human cars. In some embodiments, the bone conduction sound generation unit may be provided on the side of the housing of the acoustic output device that contacts the human face, and the bone conduction sound generation unit generates bone conduction sound waves transmitted to the human car via bone. The piezoelectric sound generation unit may be provided on the side of the housing of the acoustic output device that does not contact the human face, a mechanical vibration generated by the piezoelectric sound generation unit is transmitted to the housing, and the housing generates the bone conduction sound waves that are transmitted to the human car via bone. Alternatively, the housing generates air conduction sound waves that are transmitted to the human car via air. Alternatively, the mechanical vibration of the piezoelectric sound generation unit drives the surrounding air to vibrate, and then the air conduction sound waves that are transmitted to the human car via air are generated. The acoustic output device provided in the embodiments of the present disclosure expands the frequency response range of the acoustic output device by supplementing the high-frequency sound output using the piezoelectric sound generation unit, achieving a more translucent sound with richer details in the subjective hearing.

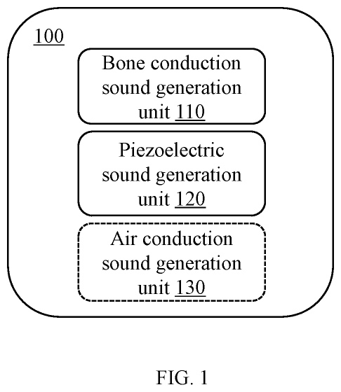

FIG. 1 is a block diagram illustrating an acoustic output device according to some embodiments of the present disclosure. As shown in FIG. 1, the acoustic output device 100 may include a bone conduction sound generation unit and a piezoelectric sound generation unit.

The acoustic output device 100 is configured to convert an audio signal (e.g., an electrical signal containing acoustic information) into an acoustic signal. In some embodiments, the acoustic signal may include bone conduction sound waves and/or air conduction sound waves. For example, the acoustic output device 100 may generate, in response to receiving the audio signal, a mechanical vibration to output sound waves (i.e., the acoustic signal) that may be delivered to the human cars by way of bone conduction or air conduction. The process of conversion described above may involve the coexistence and conversion of many different types of energy, e.g., an optical signal (i.e., a signal containing acoustic information) may be converted to the acoustic signal. Other types of energy that may coexist and be converted during the operation of the acoustic output device 100 include thermal energy, magnetic energy, or the like. In some embodiments, the acoustic output device 100 may include one or more of a moving coil type, an electrostatic type, a piezoelectric type, a moving iron type, a pneumatic type, an electromagnetic type, or the like.

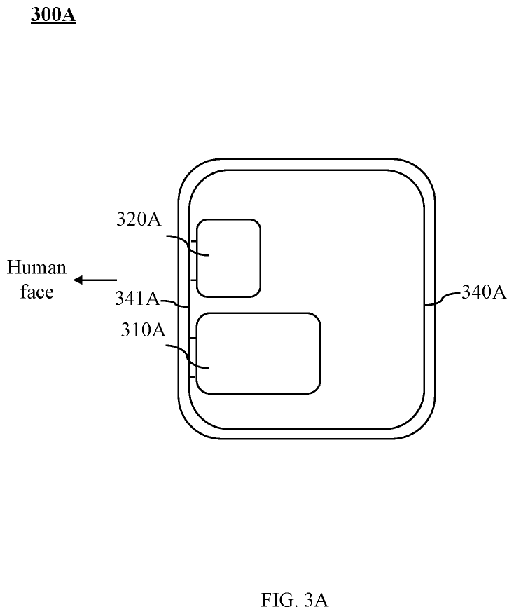

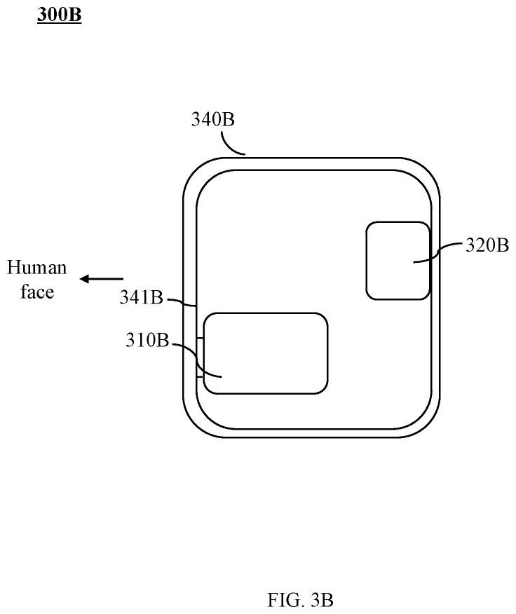

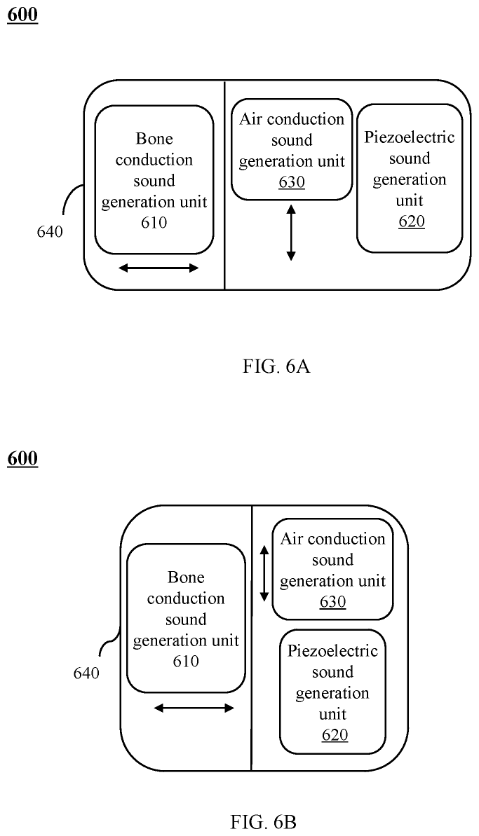

The bone conduction sound generation unit 110 is configured to convert the audio signal into bone conduction sound waves. In some embodiments, the bone conduction sound generation unit 110 may include a vibration member (also referred to as a transducer) and a vibration transmission member. At least a portion of the structure of the vibration transmission member (e.g., a side of the body of the vibration transmission member or a silicone layer covering the body of the vibration transmission member) may be in direct contact with the user's facial region, and the vibration member may respond to the audio signal to generate a mechanical vibration. The vibration transmission member may vibrate in response to the vibration of the vibration member, and transmit the vibration (i.e., bone conduction sound waves) it receives directly to the human cars through the user's muscles, bones, blood, etc. In some embodiments, the acoustic output device 100 may include a housing, and the vibration member is connected to the housing or directly connected to the housing via an elastic member (e.g., a vibration transmission sheet), so that at least a portion of the structure of the housing (e.g., a sidewall of the housing or a silicone layer that covers the sidewall) may contact the user's facial region when the user wears the acoustic output device 100, and the housing may transmit the vibration (i.e., bone conduction sound waves) it receives directly to the human car through the user's muscles, bones, blood, etc. It is to be known that, when the bone conduction sound generation unit 110 outputs the bone conduction sound waves, the vibration of the bone conduction sound generation unit 110 also drives the surrounding air to vibrate, thereby generating a small amount of air conduction sound waves. More description regarding the bone conduction sound generation unit 110 may be found in other parts of the present disclosure, such as FIG. 3A, FIG. 3B, FIG. 6A-FIG. 9, and their related descriptions.

The piezoelectric sound generation unit 120 is configured to convert the audio signal into bone conduction sound waves and/or air conduction sound waves. For illustration purposes only, in the present disclosure, the bone conduction sound waves generated by the bone conduction sound generation unit may also be referred to as first bone conduction sound waves and the bone conduction sound waves generated by the piezoelectric sound generation unit may also be referred to as second bone conduction sound waves, and the air conduction sound waves generated by the air conduction sound generation unit may also be referred to as first air conduction sound waves and the air conduction sound waves generated by the piezoelectric sound generation unit may also be referred to as second air conduction sound waves. It should be noted that the “first” and “second” here are only for distinction, and in some embodiments, the “first” and “second” can be used interchangeably. In some embodiments, the piezoelectric sound generation unit 120 may include one or more piezoelectric members, each of which may be configured to generate a vibration based on the audio signal. In some embodiments, the audio signal acting on a piezoelectric layer of the piezoelectric members causes the piezoelectric layer to deform, i.e., generate the vibration. When the piezoelectric sound generation unit 120 is configured to convert the audio signal into the bone conduction sound waves, the piezoelectric sound generation unit 120 directly or indirectly (e.g., through the housing, the vibration transmission member or the silicone layer covering the sidewall of the housing, the vibration transmission member or the piezoelectric sound generation unit 120) contacts the user's facial region, transmits the vibration through the user's muscles, bones, blood, etc. to the human cars, thus realizing the output of bone conduction sound waves. In some embodiments, the piezoelectric sound generation unit 120 may include a piezoelectric member and a vibration transmission sheet, and the piezoelectric member may be connected to the housing through the vibration transmission sheet. The piezoelectric member generates the vibration under the action of a driving voltage, the piezoelectric member drives the vibration transmission sheet to generate the mechanical vibration, and the vibration transmission sheet transmits the mechanical vibration to the housing and then transmits the mechanical vibration to the user's facial region via the housing to generate the bone conduction sound waves. In some embodiments, the piezoelectric sound generation unit 120 may also be configured to convert the audio signal into the air conduction sound waves. For example, the piezoelectric sound generation unit 120 generates the vibration based on the audio signal and transmits the vibration to the housing, where the vibration of the housing drives the surrounding air to vibrate, thereby generating the air conduction acoustic waves. Alternatively, the piezoelectric sound generation unit 120 drives the air around the piezoelectric sound generation unit 120 to vibrate, thereby generating the air conduction sound waves. In some embodiments, the piezoelectric sound generation unit 120 may include a piezoelectric member and a diaphragm, and the piezoelectric member is connected to the diaphragm. The piezoelectric member vibrates in response to the audio signal and drives the diaphragm, and the diaphragm drives the surrounding air to vibrate to generate the air conduction sound waves. In some embodiments, the piezoelectric sound generation unit 120 may include a piezoelectric member and a vibration transmission sheet, and the piezoelectric member may be connected to the housing through the vibration transmission sheet. The piezoelectric member generates a vibration under the action of the driving voltage, the piezoelectric member drives the vibration transmission sheet to generate a mechanical vibration, and the piezoelectric member drives the surrounding air to vibrate when it generates the mechanical vibration, thereby generating the air conduction sound waves. Further, the vibration transmission sheet transmits the mechanical vibration to the housing, the housing generates the mechanical vibration and drives the surrounding air to vibrate, thereby generating the air conduction sound waves. In some embodiments, the housing may include one or more sound guiding holes, and the air conduction sound waves inside the housing may be radiated to the outside world through the sound guiding holes, and thus received by the human cars. It is to be known that when the piezoelectric sound generation unit 120 outputs the bone conduction sound waves, the vibration of the piezoelectric sound generation unit 120 also drives the surrounding air to vibrate, thus generating a small amount of air conduction sound waves. When the piezoelectric sound generation unit 120 outputs the air conduction sound waves, the vibration of the piezoelectric sound generation unit 120 also drives a portion of the acoustic output device 100 that contacts the human face to vibrate, thereby generating a small amount of bone conduction sound waves. More description regarding the piezoelectric sound generation unit 120 may be found in other parts of the present disclosure, for example, FIG. 3A-FIG. 6B and their related descriptions.

As described above, the mechanical vibration (i.e., the bone conduction acoustic wave) output by the bone conduction sound generation unit 110 has at least one resonance peak in a frequency range of not higher than 1 kHz. That is, the bone conduction sound generation unit 110 has a relatively good acoustic output near a resonance frequency corresponding to the resonance peak of the bone conduction sound generation unit 110. In some embodiments, the bone conduction sound generation unit 110 generates bone conduction acoustic waves with at least one resonance peak in a frequency range of 100 Hz-1 kHz. In some embodiments, the bone conduction sound unit 110 generates bone conduction acoustic waves with at least one resonance peak in a frequency range of 200 Hz-900 Hz. In some embodiments, the bone conduction sound generation unit 110 generates bone conduction acoustic waves with at least one resonance peak in a frequency range of 300 Hz-800 Hz. The piezoelectric sound generation unit 120 utilizes the properties of the piezoelectric member (e.g., the intrinsic frequency of the piezoelectric member) to have relatively good sensitivity even at relatively high frequencies (e.g., 1000 Hz-40000 Hz), so that the sound waves (the bone conduction sound waves or the air conduction sound waves) outputted by the piezoelectric sound generation unit 120 have sound waves with at least one resonance peak in a range not less than 6 kHz (e.g., in a frequency range of 6 kHz-40 kHz). That is, the piezoelectric sound generation unit 120 has a relatively good acoustic output effect near the resonance frequency corresponding to the resonance peak of the piezoelectric sound generation unit 120. In some embodiments, the piezoelectric sound generation unit 120 may output sound waves with at least one resonance peak in a range greater than 7 kHz. In some embodiments, the piezoelectric sound generation unit 120 may output sound waves with at least one resonance peak in a range greater than 8 kHz. In some embodiments, the piezoelectric sound generation unit 120 may output sound waves with at least one resonance peak in a range greater than 9 kHz. Specifically, in some embodiments, the piezoelectric sound generation unit 120 may output sound waves with one resonance peak near 10 KHz. The acoustic output device 100 has both the bone conduction sound generation unit 110 and the piezoelectric sound generation unit 120, which allows the acoustic output device 100 to output a sound that covers the mid-range frequencies to the high frequencies, thereby expanding the frequency range of the acoustic output device 100 and supplementing the high-frequency sound output accordingly, thus achieving a more translucent and detailed sound in the user's subjective sense of hearing.

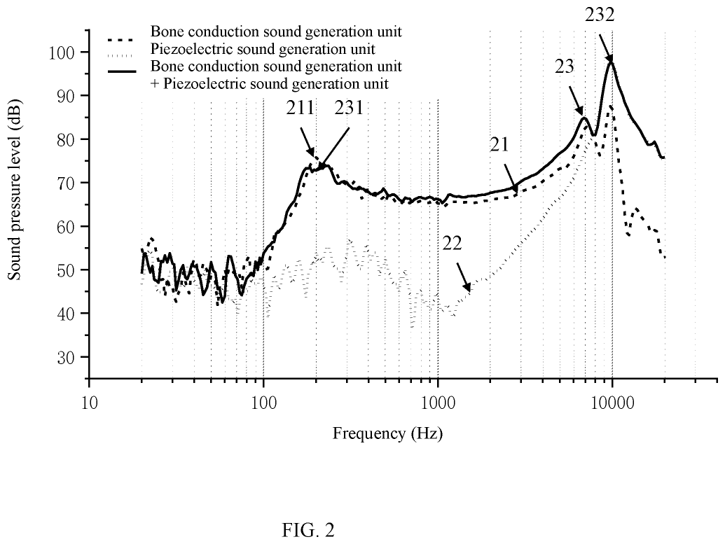

The utility of the piezoelectric sound generation unit 120 for supplementing the high-frequency sound output is described herein in connection with FIG. 2. FIG. 2 is a graph illustrating frequency response curves of a bone conduction sound generation unit, a piezoelectric sound generation unit, and a combination thereof, according to some embodiments of the present disclosure. In FIG. 2, the horizontal coordinate indicates a frequency (Hz), and the vertical coordinate indicates a sound pressure level (dB) of the acoustic output device at different frequencies. Frequency curve 21 is a frequency response curve in which the acoustic output device has only the bone conduction sound generation unit, frequency curve 22 is a frequency response curve in which the acoustic output device has only the piezoelectric sound generation unit, and frequency curve 23 is a frequency response curve in which the acoustic frequency response curve of the acoustic output device has the bone conduction sound generation unit and the piezoelectric sound generation unit. As shown in FIG. 2, the frequency curve 21 has a resonance peak 211 in a frequency range of 100 Hz-1 kHz, and the sound pressure level decreases substantially at a frequency greater than 10 kHz. The frequency curve 22 has a relatively low sound pressure level in a frequency range of 100 Hz-1 kHz, abut in the frequency range of 6 kHz-10 kHz, due to a high resonance frequency of the piezoelectric member, the sound pressure level increases substantially and reaches a peak near 10 kHz. The frequency curve 23 of the combination of the bone conduction sound generation unit 110 and the piezoelectric sound generation unit 120 has a resonance peak 231 in the frequency range of 100 Hz-1 kHz and a resonance peak 232 in the frequency range of 6 KHz-10 KHz. At a frequency greater than 10 kHz, the sound pressure level of the acoustic output device having the bone conduction sound generation unit 110 and the piezoelectric sound generation unit 120 is substantially higher than the sound pressure level of the acoustic output device having only the bone conduction sound generation unit 110. Thus, according to FIG. 2, the piezoelectric sound generation unit 120 may supplement the high-frequency output of the bone conduction sound generation unit 110 to enhance the translucency of the output sound. The frequency response curve between the resonance peak 231 and the resonance peak 232 is relatively flat, which also ensures that the combination of the bone conduction sound generation unit 110 and the piezoelectric sound generation unit 120 has a better sound quality.

In some embodiments, the acoustic output device 100 may include at least one excitation source, and the excitation source may be used to provide an excitation voltage to the piezoelectric member and the bone conduction sound generation unit 110. The piezoelectric member and the bone conduction sound generation unit 110 vibrate due to the excitation voltage. To some extent, the excitation voltage provided by the excitation source may be understood to be an audio signal. In some embodiments, the excitation voltage provided by the excitation source may be an audio signal that has been processed by a voltage conversion (e.g., boosting or bucking). In some embodiments, one excitation source may provide the same excitation voltage to the piezoelectric member and the bone conduction sound generation unit 110. Alternatively, two excitation sources may provide the same excitation voltage to the piezoelectric member and the bone conduction sound generation unit 110, respectively, to drive the piezoelectric member and the bone conduction sound generation unit 110 to vibrate by the same excitation voltage. In some embodiments, the excitation source may provide a relatively low excitation voltage to the piezoelectric member and the bone conduction sound generation unit 110, and driven by the lower excitation voltage, the bone conduction sound generation unit 110 mainly generates low-frequency (e.g., 20 Hz-500 Hz), medium-high-frequency (e.g., 500 Hz-6 kHz), and high-frequency (e.g., 6 kHz-20 kHz) sound waves. Due to a relatively high resonance frequency of the piezoelectric member, the piezoelectric member mainly generates high-frequency sound waves. Correspondingly, relatively few low-frequency and medium-high-frequency sound waves are generated by the piezoelectric member, which facilitates the cooperation between the piezoelectric sound generation unit 120 and the bone conduction sound generation unit 110, thereby enabling the acoustic output device 100 to output the high-frequency, medium-high-frequency, and low-frequency sound waves by the bone conduction sound generation unit 110 and output the high-frequency sound waves by the piezoelectric sound generation unit 120 without providing a frequency divider circuit, so that the acoustic output device 100 has a better acoustic output effect in all frequency bands. In addition, when the acoustic output device 100 is in operation, the bone conduction sound generation unit 110 mainly outputs low-frequency, medium-high-frequency, and high-frequency sound waves, and the piezoelectric sound generation unit 120 mainly outputs high-frequency sound waves, whereas the sound pressure level of the high-frequency sound waves output by the bone conduction sound generation unit 110 is reduced when the frequency is greater than a specific frequency (e.g., 10 KHz). The high-frequency sound waves output by the piezoelectric sound generation unit 120 may compensate for the insufficient high-frequency output of the bone conduction sound generation unit 110, thereby improving the acoustic output effect of the acoustic output device 100 at high frequencies.

The resonance frequency of the piezoelectric member is related to the mass and stiffness of the piezoelectric member. In some embodiments, the resonance frequency of the piezoelectric member may be adjusted by adjusting parameters related to the mass and the stiffness of the piezoelectric member (e.g., length, width, thickness, or material, etc.). For example, the resonance frequency of the piezoelectric member may be reduced by increasing the mass of the piezoelectric member. In some embodiments, there may be one or more piezoelectric members. In some embodiments, the plurality of piezoelectric members may be the same piezoelectric member, i.e., have the same resonance frequency. High-frequency bone conduction sound waves output by the plurality of the same piezoelectric members may be superimposed to increase the acoustic compensation effect of the acoustic output device in a particular frequency band (e.g., high-frequency). In some embodiments, the plurality of piezoelectric members may be different piezoelectric members, i.e., a plurality of piezoelectric members have different resonance frequencies, and the different piezoelectric members may compensate for the sound pressure levels of the bone conduction sound generation unit 110 in different frequency bands. For example, the piezoelectric sound generation unit 120 includes a first piezoelectric member and a second piezoelectric member. The first piezoelectric member has a resonance frequency of 8 kHz and the second piezoelectric member has a resonance frequency of 12 kHz. The first piezoelectric member may compensate for the sound pressure level of the bone conduction sound generation unit 110 in a frequency range of 5 kHz-10 kHz, and the second piezoelectric member may compensate for the sound pressure level of the bone conduction sound generation unit 110 in a frequency range of 10 kHz-14 kHz.

In some embodiments, the acoustic output device 100 may further include a first boosting circuit, the first boosting circuit being used to boost the excitation voltage generated by the excitation source for driving the piezoelectric member. A higher excitation voltage enables the piezoelectric member to generate sound waves with a higher frequency, avoiding the piezoelectric member being unable to generate sufficiently high-frequency sound waves due to low resonance frequency. In some embodiments, the piezoelectric sound generation unit 120, driven by a higher excitation voltage, may have sound waves with at least one resonance peak in a range not less than 7 kHz. Merely by way of example, when the piezoelectric sound generation unit 120 has a resonance frequency of 8 kHz, the piezoelectric sound generation unit 120 needs to compensate for the output of the bone conduction sound generation unit 110 in a frequency range of 10 kHz-14 kHz. The excitation voltage of the piezoelectric sound generation unit 120 may be boosted using the boosting circuit, and the piezoelectric sound generation unit 120, driven by the boosted excitation voltage, may cause the piezoelectric sound generation unit 120 to output sounds with a higher sound pressure level within a range of 10 kHz-14 kHz, such that the piezoelectric sound generation unit 120 compensates for the output of the bone conduction sound generation unit 110 in the frequency range of 10 kHz-14 kHz.

In some embodiments, the acoustic output device 100 may further include a frequency divider circuit, the frequency divider circuit being configured to generate a first frequency range signal and a second frequency range signal based on a first frequency division point. The first frequency point is set in a high-frequency range (e.g., 5 kHz-40 kHz), for example, the first frequency point may be 5 kHz, a signal lower than the first frequency point is a first frequency range signal, a signal higher than the first crossover frequency point is a second frequency range signal. The first frequency range signal is used to drive the bone conduction sound generation unit 110 to generate medium-frequency sound waves, and the second frequency range signal is used to drive the piezoelectric sound generation unit 120 to generate high-frequency sound waves. The frequency divider circuit is utilized to generate signals of different frequency ranges, which are used to drive the bone conduction sound generation unit 110 and the piezoelectric sound generation unit 120, respectively. In such cases, the bone conduction sound generation unit 110 concentrates on generating medium-frequency sound waves, the piezoelectric sound generation unit 120 focuses on generating high-frequency sound waves, and the piezoelectric sound generation unit 120 can generate sound waves of sufficiently high frequency to compensate for the high-frequency output of the acoustic output device 100. In some embodiments, to enable the piezoelectric sound generation unit 120, which has a relatively low resonance frequency, to generate sufficiently high-frequency sound waves, the acoustic output device 100 may also include a second boosting circuit, and the second boosting circuit functions similar to the first boosting circuit to boosting the second frequency range signal. The boosted second frequency range signal may enable the piezoelectric sound generation unit 120 to generate higher frequency sound waves compared to the second frequency range signal with a low voltage.

In some embodiments, the acoustic output device 100 may further include an air conduction sound generation unit 130. The air conduction sound generation unit 130 is configured to convert the audio signal into air conduction sound waves with at least one resonance peak in a frequency range not higher than 500 Hz (e.g., in a frequency range of 20 Hz-500 Hz). That is to say, the air conduction sound generation unit 130 has a relatively good acoustic output effect, i.e., a volume of the output sound is relatively large, near a resonance frequency corresponding to the resonance peak of the air conduction sound generation unit 130. In some embodiments, the acoustic output device 100 may have the air conduction sound generation unit 130, the bone conduction sound generation unit 110, and the piezoelectric sound generation unit 120. The air conduction sound generation unit 130 is mainly used for low-frequency output, the bone conduction sound generation unit 110 is mainly used for medium-frequency output, and the piezoelectric sound generation unit 120 is mainly used for high-frequency output, so that the output sound of the acoustic output device 100 may cover from low-frequency to high-frequency, and the strength of the sound output may be improved in the full frequency range, thereby effectively improving the overall sound quality.

In some embodiments, the acoustic output device 100 includes a frequency divider circuit that divides the first frequency range signal based on a second frequency division point to generate a first sub-frequency range signal and a second sub-frequency range signal, the second frequency divider point being in the medium-frequency range (e.g., 500 Hz-1 kHz). For example, the second frequency division point may be 500 Hz. A signal lower than the second frequency division point is the first sub-frequency range signal, and a signal higher than the second frequency division point is the second sub-frequency range signal. The first sub-frequency range signal is used to drive the air conduction sound generation unit 130 to generate low-frequency sound waves, and the second sub-frequency range signal is used to drive the bone conduction sound generation unit 110 to generate medium-frequency sound waves. More description regarding the air conduction sound generation unit 130 may be found in other parts of the present disclosure, such as FIG. 6A-FIG. 6B and their related descriptions.

Various embodiments of the acoustic output device 100 comprising a bone conduction sound generation unit and a piezoelectric sound generation unit may be illustrated hereinafter in conjunction with FIG. 3A-FIG. 5.

FIG. 3A is a schematic diagram illustrating an exemplary structure of an acoustic output device according to some embodiments of the present disclosure. As shown in FIG. 3A, an acoustic output device 300A may include a housing 340A, a bone conduction sound generation unit 310A, and a piezoelectric sound generation unit 320A. The housing 340A is a three-dimensional structure with an internal accommodation space (also referred to as an accommodation cavity), so that a sidewall 341A of the housing 340A may directly contact the human face when the user wears the acoustic output device 300A. In some embodiments, the sidewall 341A may be one sidewall of the housing 340A. In some embodiments, the sidewall 341A may be independently disposed with respect to the housing 340A, and the sidewall 341A is connected to the housing 340A via an elastic member (e.g., a vibration-dampening sheet). In some embodiments, the bone conduction sound generation unit 310A may be provided in the accommodation space of the housing 340A and connected to the sidewall 341A or other sidewalls of the housing 340A either through the elastic member (e.g., the vibration transmission sheet and/or the vibration dampening sheet) or directly. The piezoelectric sound generation unit 320A may be directly connected to the sidewall 341A, and both the bone conduction sound generation unit 310A and the piezoelectric sound generation unit 320A are provided to produce vibrations that may be transmitted directly to the user's muscles, bones, blood, etc., or through the sidewall 341A. In some embodiments, the piezoelectric sound generation unit 320A may include only a piezoelectric member, and the piezoelectric member may be disposed on an inner surface or an outer surface of the sidewall 341A or embedded in the sidewall 341A. The piezoelectric member may be a plate-like structure, with at least some of the edges of the piezoelectric member connected to the sidewall 341A. For example, the piezoelectric member may be a circular plate-like structure with a peripheral edge fixed to the sidewall 341A. When signals pass through the piezoelectric member, a region of the piezoelectric member that is not fixed to the sidewall 341A is deformed to produce a vibration, and the vibration is transmitted to the user. Alternatively, in some embodiments, the piezoelectric member may be a circular plate-like structure with an outer peripheral edge or an inner peripheral edge fixed to the sidewall 341A. When signals pass through the piezoelectric member, the region of the piezoelectric member that is not fixed to the sidewall 341A may be deformed to produce a vibration, and the vibration is transmitted to the user. In some other embodiments, the piezoelectric sound generation unit 320A may include a piezoelectric member and a vibrating plate (not shown in the figures), the piezoelectric member and the vibrating plate being disposed within the housing 340A. The piezoelectric member is fixed within the accommodation space of the housing 340A by a support structure (e.g., a bracket). The piezoelectric member is connected to the sidewall 341A via the vibrating plate, one side of the vibrating plate is connected to the sidewall 341A, and the other side of the vibration plate is connected to the piezoelectric member. The piezoelectric member generates the vibration under the action of the driving voltage, the piezoelectric member drives the vibrating plate to generate the mechanical vibration, and the vibrating plate transmits the mechanical vibration to the housing 340A and transmits the mechanical vibration to the facial region of the user via the sidewall 341A of the housing 340A to generate the bone conduction sound waves. It is noted that the vibrating plate may be a structure that is independent of the housing 340A or the sidewall of the housing 340A, or a structure that is integrally molded with the housing 340A or the sidewall of the housing 340A.

In some embodiments, the housing 340A may be a cuboid structure. In some embodiments, the housing 340A may also be a regular structure such as a cylindrical structure, an ellipsoidal structure, a ladder table structure, or the like, or an irregular structure. In some embodiments, the accommodation space inside the housing 340A has the same as or a different shape from the outer contour of the housing 340A. For example, the outer contour of the housing 340A may be a cuboid, and the accommodation space may be a cuboid. As another example, the outer contour of the housing 340A may be a cuboid and the accommodation space may be a sphere.

Taking the housing 340A being a cuboid structure as an example, an outer side surface of the sidewall 341A of the housing 340A with respect to the accommodation space may directly contact the human face. The bone conduction sound generation unit 310A may be connected to the sidewall 341A through the vibration transmission member. The vibration transmission member vibrates in response to the vibration of the bone conduction sound generation unit 310A and transmits the vibration received therein to the sidewall 341A. Then the sidewall 341A transmits the vibration to the facial region of the user.

In some embodiments, the piezoelectric sound generation unit 320A may be provided on an inner side surface of the sidewall 341A. At least a portion of the structure of the piezoelectric sound generation unit 320A may be connected to the sidewall 341A. For example, the piezoelectric member of the piezoelectric sound generation unit 320A may be a sheet-like structure, the inner side surface of the sidewall 341A is provided with a groove, the piezoelectric member is disposed in the groove, the edge of the piezoelectric member is connected to the corresponding sidewall of the groove, the piezoelectric member and a bottom wall of the groove are approximately parallel, and the piezoelectric member is spaced apart from the bottom wall of the groove to ensure that the piezoelectric member may vibrate under the action of the driving voltage. As another example, the piezoelectric sound generation unit 320A may include a vibrating plate and a piezoelectric member, and the piezoelectric member is connected to the inner side surface of the sidewall 341A via the vibrating plate. The vibrating plate vibrates in response to the vibration of the piezoelectric member and transmits the vibration to the sidewall 341A. Then the sidewall 341A transmits the vibration to the user's facial region. In some embodiments, the piezoelectric sound generation unit 320A may be disposed on the outer side surface of the sidewall 341A and connected to the sidewall 341A, and at least a portion of the structure of the piezoelectric sound generation unit 320A may directly contact the user's facial region, so that mechanical vibration of the piezoelectric sound generation unit 320A may be transmitted directly to the user's facial region. It should be noted that the inner side surface of the sidewall 341A is a side of the sidewall 341A that contacts the accommodation space. Correspondingly, the outer side surface of the sidewall 341A is a side of the sidewall 341A that is away from the accommodation space. In some embodiments, an aperture is provided on the sidewall 341A. The aperture penetrates the sidewall 341A, and an edge of the piezoelectric member is connected to an aperture wall corresponding to the aperture. In some embodiments, the sidewall of the housing 340A where the piezoelectric member is located may be covered with a protective layer (e.g., a silicone layer) to protect the piezoelectric member and increase the comfort of the user while wearing the acoustic output device. In some embodiments, the connection between the piezoelectric sound generation unit 320A and the sidewall 341A is achieved by connecting a portion of the piezoelectric sound generation unit 320A to the sidewall 341A. For example, an edge or middle of the piezoelectric sound generation unit 320A is connected to the sidewall 341A, avoiding that a large portion of the piezoelectric sound generation unit 320A is fixed to the sidewall 341A and affects the vibration of the piezoelectric sound generation unit 320A. In some embodiments, the piezoelectric member of the piezoelectric sound generation unit 320A may be a plate-like structure, and the piezoelectric member may be a plate-like structure in a rectangular, circular, toroidal, elliptical, semicircular, polygonal, and other regular or arbitrary irregular shape. Taking the piezoelectric member being a circular plate-like structure as an example, an edge of the piezoelectric member is connected to the sidewall 341A, and a main body portion of the piezoelectric member (except for a portion of an edge region) is suspended with respect to the sidewall 341A. Taking the piezoelectric member being an annular plate-like structure as an example, the outer edge of the piezoelectric member is connected to the sidewall 341A, and the main body portion of the piezoelectric member (except for the outer edge portion) is suspended with respect to the sidewall 341A, or the piezoelectric member may be socketed to the sidewall 341A if the dimension of the piezoelectric member is larger than that of the sidewall 341A.

In some embodiments, when the piezoelectric sound generation unit 320A is mainly used to output the bone conduction acoustic waves, an included angle between a vibration direction of the piezoelectric sound generation unit 320A and a vibration direction of the bone conduction sound generation unit 310A may be within a range of −45°-45°, so that the sound wave generated by the piezoelectric sound generation unit 320A and the sound waves generated by the bone conduction sound generation unit 310A cancel with each other as little as possible, thereby improving the output capability and output effect of the bone conduction acoustic waves. In some embodiments, the included angle between the vibration direction of the piezoelectric sound generation unit 320A and the vibration direction of the bone conduction sound generation unit 310A may be within a range of −20°-20°. In some embodiments, the vibration direction of the piezoelectric sound generation unit 320A may be approximately the same as the vibration direction of the bone conduction sound generation unit 310A. In some embodiments, the vibration direction of the piezoelectric sound generation unit 320A may be the same as the vibration direction of the bone conduction sound generation unit 310A.

FIG. 3B is a schematic diagram illustrating an exemplary structure of an acoustic output device according to some other embodiments of the present disclosure. The overall structure of the acoustic output device 300B shown in FIG. 3B is substantially the same as that of the acoustic output device 300A shown in FIG. 3A, with the main difference that the piezoelectric sound generation unit 320B is placed on a side opposite to the sidewall 341B. The vibration generated by the piezoelectric sound generation unit 320B is transmitted to the housing 340B, the housing 340B receives the vibration and causes the surrounding air to vibrate to generate air conduction sound waves. As described above, in this case, the mechanical vibration generated by the piezoelectric sound generation unit 320B may also be transmitted to the user's muscles, bone, blood, or the like, via the housing 340B to generate the bone conduction sound waves. The structures of the housing 340B, the bone conduction sound generation unit 310B, and the piezoelectric sound generation unit 320B shown in FIG. 3B are similar to the structures of the housing 340A, the bone conduction sound generation unit 310A, and the piezoelectric sound generation unit 320A shown in FIG. 3A, and are not repeated herein.

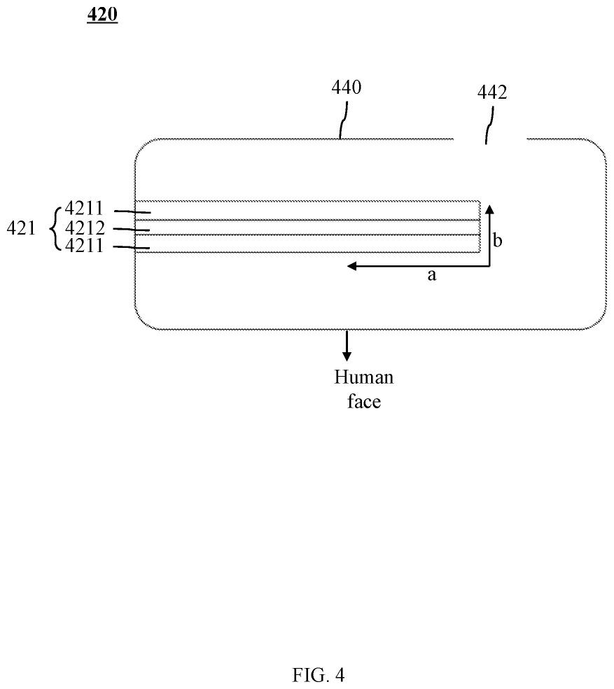

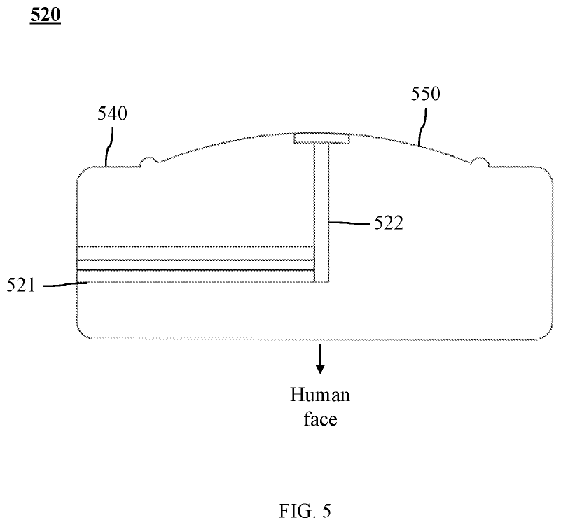

Taking the housing 340B being a cuboid structure as an example, in some embodiments, the piezoelectric sound generation unit 320B may be disposed on a sidewall of the housing 340B opposite or adjacent to the sidewall 341B, and a portion of the vibration of the piezoelectric sound generation unit 320B may be transmitted to the sidewall 341B via the sidewall opposite or adjacent to the sidewall 341B of the housing 340B, thereby generating the bone conduction sound waves. In some embodiments, the piezoelectric sound generation unit 320B may be disposed on an inner side surface or an outer side surface of the sidewall of the housing 340B that is opposite or adjacent to the sidewall 341B, or embedded into the sidewall of the housing 340B that is opposite or adjacent to the sidewall 341B. It should be noted that when the piezoelectric sound generation unit 320B is disposed in the sidewall of the housing 340B that is opposite or adjacent to the sidewall 341B, the vibration of the piezoelectric sound generation unit 320B may also drive the air surrounding the piezoelectric sound generation unit 320B to vibrate to generate air conduction sound waves. Meanwhile, the vibration of the piezoelectric sound generation unit 320B is transmitted to the housing 340B, and the vibration of the housing 340B causes vibration of the air surrounding the housing 340B to generate the air conduction sound waves. In particular, when the piezoelectric sound generation unit 320B is disposed on a sidewall of the housing 340B that is opposite to the sidewall 341B, the vibration of the mechanical vibration generated by the piezoelectric sound generation unit 320B and transmitted to the sidewall 341B may have a significant loss. In such cases, the vibration of the piezoelectric sound generation unit 320B mainly causes the vibration of the piezoelectric sound generation unit 320B and the air surrounding the housing 340B to generate the air conduction sound waves. In some embodiments, the piezoelectric sound generation unit 320B may also be disposed at any other location where the housing 340B does not contact the human face. For example, the piezoelectric sound generation unit 320B may be suspended within the accommodation space of the housing 340B, and the vibration of the piezoelectric unit drives the surrounding air to vibrate to generate the air conduction sound waves. In some embodiments, the housing 340B may be provided with sound guiding holes (not shown in FIG. 3B), and the sound guiding holes are configured to radiate the air conduction acoustic waves generated by the piezoelectric sound generation unit 320B within the accommodation space to the outside world, so that the sound waves are received by the human cars. In some embodiments, the piezoelectric sound generation unit 320B may include a piezoelectric member, a vibration transmission member, and a diaphragm. One end of the piezoelectric member is connected to the housing 340B of the acoustic output device, and the other end of the piezoelectric member is suspended within the housing 340B. The diaphragm is provided on a side of the housing 340B that is away from the human body, and the vibration transmission member is provided in the accommodation space of the housing 340B. On end of the vibration transmission member is connected to the piezoelectric member and another end of the vibration transmission member is connected to the diaphragm. The piezoelectric element drives the diaphragm to vibrate through the transmission element, and the diaphragm drives the surrounding air to vibrate to generate the air conduction sound waves that are received by the human cars. In some embodiments, the diaphragm may be disposed on a sidewall of the housing 340B that is adjacent or opposite to the sidewall 341B and the diaphragm may be regarded as a portion of the sidewall. Alternatively, the diaphragm may be disposed in the accommodation space, and the housing 340B may be provided with the sound guiding holes. The sound guiding holes are configured to radiate the air conduction sound waves generated by the piezoelectric sound generation unit 320B in the accommodation space to the outside world such that the air conduction sound waves are received by the human cars. Various embodiments in which the piezoelectric sound generation unit 320B is mainly used for generating the air conduction sound waves may be described hereinafter in conjunction with FIG. 4 and FIG. 5.

FIG. 4 is a schematic diagram illustrating an exemplary structure of a piezoelectric sound generation unit according to some embodiments of the present disclosure. As shown in FIG. 4, the piezoelectric sound generation unit 420 includes a piezoelectric member 421, with one end of the piezoelectric member 421 being connected to a housing 440 of the acoustic output device, and the other end being suspended in an accommodating space of the housing 440. Sound guiding holes 442 are provided on a side of the housing 440 that is away from the human body. The housing 440 illustrated in FIG. 4 is similar to the housing 340A illustrated in FIG. 3A and may not be repeated here.

In some embodiments, the piezoelectric member 421 includes a fixed end and a free end. The fixed end is an end on the piezoelectric member 421 that provides a fixing or support function for other portions. In some embodiments, during the vibration of the piezoelectric member 421, a vibration intensity at the fixed end is less relative to other portions of the piezoelectric member 421 (e.g., the free end). Merely by way of example, the fixed end may be a location on the piezoelectric member 421 where a vibration acceleration or an acceleration level is less than a vibration acceleration threshold or an acceleration level threshold. In some embodiments, the fixed end may be connected to a fixed location or structure of the acoustic output device. The fixed location or structure herein refers to a location or a structure on the acoustic output device where the vibration acceleration or acceleration level is less than the vibration acceleration threshold or acceleration level threshold. The fixed end shown in FIG. 4 is connected to the housing 440. The free end is the end of the piezoelectric member 421 that generates sound, which is away from the fixed end and may vibrate more freely relative to the fixed end. The free end shown in FIG. 4 is an end of the piezoelectric member 421 that is suspended. In some embodiments, the piezoelectric member 421 may be a plate, a strip structure, or other structure of any length greater than the width and thickness thereof. For example, the piezoelectric member 421 may be a prismatic structure. The length is a dimension along a length direction (refer to direction a shown in FIG. 4), the thickness is a dimension along a thickness direction (refer to direction b shown in FIG. 4), and the width is a dimension along a width direction (simultaneously perpendicular to the length direction and the thickness direction).

In some embodiments, the piezoelectric member 421 may include a piezoelectric layer 4211 and a substrate layer 4212. In some embodiments, the piezoelectric layer 4211 may be made of a piezoelectric material. In some embodiments, the material of the substrate layer 4212 includes, but is not limited to metals and alloys, resins, glass fibers, carbon fibers, or the like, or any combination thereof. In some embodiments, the piezoelectric layer 4211 and the substrate layer 4212 are overlapped in the thickness direction of the piezoelectric member 421. In some embodiments, the piezoelectric layer 4211 may be physically fixed to one side of the substrate layer 4212, such as by affixing. In some embodiments, the piezoelectric member 421 may include two piezoelectric layers 4211 and a substrate layer 4212, with the two piezoelectric layers 4211 and the substrate layer 4212 being overlapped in the thickness direction of the piezoelectric member 421. In some embodiments, the piezoelectric member 421 may include a plurality of piezoelectric layers 4211, the plurality of piezoelectric layers 4211 and the substrate layer 4212 being provided in a stacked manner.

In some embodiments, the sound guiding holes 442 may be provided at any other position where the housing 440 does not contact the human face, e.g., the sound guiding holes 442 may be provided on a sidewall of the housing 440 that is adjacent to the sidewall that contacts the human face. In some embodiments, an accommodation cavity of the housing 440 is in flow communication with the exterior of the housing 440 through the sound guiding holes 442. In some embodiments, the sound guiding holes 442 penetrate the sidewall of the housing 440. In some embodiments, the sound guiding holes 442 may have regular shapes such as a rectangle, a circle, an annulus, an ellipse, a semicircle, a polygon, a triangle, or the like, or arbitrarily irregular shapes.

In some embodiments, the piezoelectric sound generation unit 420 may include a plurality of different piezoelectric members, and the plurality of piezoelectric members having different resonance frequencies. The piezoelectric members having different resonance frequencies may output air conduction sound waves of different frequency bands to compensate for the output of sound waves in different frequency bands. For example, the piezoelectric sound generation unit 420 includes a third piezoelectric member and a fourth piezoelectric member. The third piezoelectric member has a resonance frequency of 7 kHz and may output air conduction acoustic waves within a range of 4 kHz-9 kHz. The fourth piezoelectric member has a resonance frequency of 11 kHz and can output air conduction sound waves within a range of 9 kHz-12 kHz, and the combination of the third piezoelectric member and the fourth piezoelectric member may compensate for the output of sound waves in the frequency range of 4 kHz-12 KHz.

FIG. 5 is a schematic diagram illustrating an exemplary structure of a piezoelectric sound generation unit according to some embodiments of the present disclosure. As shown in FIG. 5, a piezoelectric sound generation unit 520 includes a piezoelectric member 521, a vibration transmission member 522, and a diaphragm 550. One end of the piezoelectric member 521 is connected to a housing 540 of the acoustic output device, and another end of the piezoelectric member 521 is suspended in an accommodation space of the housing 540. The diaphragm 550 is provided on a side of the housing 540 that is away from the human body. The vibration transmission member 522 is set in the accommodation space of the housing 540. One end of the vibration transmission member 522 is connected to the piezoelectric member 521 and another end of the vibration transmission member 522 is connected to the diaphragm 550. The piezoelectric member 521 drives the diaphragm 550 to vibrate via the vibration transmission member 522, and the diaphragm 550 drives the surrounding air to vibrate to generate the air conduction sound waves to be received by the human cars. In some embodiments, the diaphragm 550 may be provided on a sidewall of the housing 540, for example, the sidewall adjacent or opposite to the sidewall 341B shown in FIG. 3B. At this time, the diaphragm 550 may be considered as a portion of the sidewall, and the air conduction sound waves generated by the vibration of the diaphragm 550 may be transmitted directly to the outside world. In some embodiments, the diaphragm 550 may also be disposed in an accommodation space of the housing 540, where the housing 540 may be provided with sound guiding holes for radiating the air conduction sound waves generated by the piezoelectric sound generation unit 520 in the accommodation space to the outside world so as to be received by the human cars. The housing 540 and the piezoelectric member 521 shown in FIG. 5 are similar to the housing 440 and the piezoelectric member 421 shown in FIG. 4 and may not be repeated here.

In some embodiments, a peripheral side of the diaphragm 550 is connected to the housing 540. In some embodiments, the diaphragm 550 may be disposed at any other position of the housing 540 that does not contact the face, e.g., the diaphragm 550 may be disposed on a side of the housing 540 that is approximately perpendicular to the face.

In some embodiments, the diaphragm 550 is connected to the piezoelectric member 521 via the vibration transmission member 522. In some embodiments, one end of the piezoelectric member 521 may be connected to a sidewall of the housing 540, and another end of the piezoelectric member 521 that is away from the housing 540 is connected to the vibration transmission member 522. In some embodiments, a polarization direction of the piezoelectric member 521 is perpendicular to a stress direction. The piezoelectric member 521 is subjected to a stress along a length direction of the piezoelectric member 521 when the piezoelectric member 521 is subjected to an electric field perpendicular to a surface of the piezoelectric member 521. At this time, a piezoelectric layer of the piezoelectric member 521 deforms to drive the overall structure of the piezoelectric member 521 to deform, thereby generating vibration along the polarization direction. The vibration transmission member 522 may extend along the polarization direction of the piezoelectric member 521, the piezoelectric member 521 transmits vibration through the vibration transmission member 522, and the diaphragm 550 vibrates along the polarization direction of the piezoelectric member 521. In some embodiments, the vibration transmission member 522 may have a regular such as a rod, plate, strip structure, spiral structure, or the like, or an irregular structure. In some embodiments, the piezoelectric sound generation unit 520 may not include the vibration transmission member 522. One end of the piezoelectric member 521 is connected to the housing 540 of the acoustic output device, and another end of the piezoelectric member 521 may be directly in contact with the diaphragm 550. The piezoelectric member 521 directly drives the diaphragm 550 to vibrate to generate the air conduction sound waves.

In some embodiments, to avoid the vibration of the diaphragm 550 of the piezoelectric sound generation unit and the vibration of the bone conduction sound generation unit to interact with each other through the vibration transmission of the housing 540, a vibration direction of the diaphragm 550 may be perpendicular to a vibration direction of the bone conduction sound generation unit. Perpendicular here may be understood as approximately perpendicular. In some embodiments, an included angle between the vibration direction of the diaphragm 550 and the vibration direction of the bone conduction sound generation unit may be within a range of 70°-110°.

Various embodiments of the acoustic output device including the bone conduction sound generation unit, the piezoelectric sound generation unit, and the air conduction sound generation unit may be illustrated hereinafter in conjunction with FIGS. 6A-FIG. 6B.

FIG. 6A is a schematic diagram illustrating an exemplary structure of an acoustic output device according to some embodiments of the present disclosure. FIG. 6B is a schematic diagram illustrating an exemplary structure of an acoustic output device according to yet some more embodiments of the present disclosure. As shown in FIGS. 6A and 6B, the acoustic output device 600 includes a housing 640, a bone conduction sound generation unit 610, a piezoelectric sound generation unit 620, and an air conduction sound generation unit 630. The air conduction sound generation unit 630 is configured to output low-frequency air conduction sound waves, the bone conduction sound generation unit 610 is configured to output medium-frequency bone conduction sound waves, and the piezoelectric sound generation unit 620 is configured to output high-frequency air conduction sound waves. The housing 640 has an accommodation cavity divided into two independent chambers, the bone conduction sound generation unit 610 is separately disposed in one chamber, and the piezoelectric sound generation unit 620 and the air conduction sound generation unit 630 are disposed side-by-side (as shown in FIG. 6A) or stacked (as shown in FIG. 6B) in the other chamber, which may avoid that the vibration of the bone conduction sound generation unit 610 affects the air conduction sound waves of the piezoelectric sound generation unit 620 and the air conduction sound generation unit 630 through air transmission in the housing 640. Further description regarding the air conduction sound generation unit 630 may be found in FIG. 1, further description regarding the bone conduction sound generation unit 610 and the housing 640 may be found in FIG. 1, FIG. 3A, and FIG. 3B, and further description regarding the piezoelectric sound generation unit 620 may be found in FIG. 1 and FIG. 3B-FIG. 5.

In some embodiments, the air conduction sound generation unit 630 may include a diaphragm, which generates a vibration based on an audio signal, and the diaphragm drives the air inside the housing 640 of the acoustic output device 600 to vibrate, thereby generating the air conduction sound waves. The air conduction sound waves inside the housing 640 may be radiated to the outside world through sound guiding holes, so as to be received by the human cars. In some embodiments, the air conduction sound generation unit 630 may also include a diaphragm, a voice coil, and a magnetic circuit structure, where the diaphragm and the magnetic circuit structure are connected through the voice coil. The magnetic field inside the magnetic circuit structure changes in response to the audio signal, the voice coil vibrates under the action of the magnetic circuit structure, and the diaphragm vibrates in response to the vibration of the voice coil. It is to be understood that the diaphragm of the air conduction sound generation unit 630 and the diaphragm of the piezoelectric sound generation unit 620 are not the same in some embodiments, but are diaphragms respectively provided for transmitting the air conduction sound waves. For illustration purposes only, in some embodiments, the diaphragm of the piezoelectric sound generation unit may also be referred to as a first diaphragm, and the diaphragm of the air conduction sound generation unit may also be referred to as a second diaphragm. It should be noted that the “first” and “second” here are only for distinction, and in some embodiments, the “first” and “second” can be used interchangeably.

In some embodiments, to minimize the interference between the vibration of the bone conduction sound generation unit 610 and the vibration of the air conduction sound generation unit transmitted through the vibration of the housing 640, an included angle between a vibration direction of the diaphragm and a vibration direction of the bone conduction sound generation unit 610 may be within a range of 70°-110°. In some embodiments, the vibration direction of the diaphragm may be approximately perpendicular to the vibration direction of the bone conduction sound generation unit 610. In some embodiments, the vibration direction of the diaphragm may be perpendicular to the vibration direction of the bone conduction sound generation unit 610. In some embodiments, the piezoelectric sound generation unit 620 vibrates to generate the air conduction acoustic waves, and the vibration direction of the piezoelectric sound generation unit 620 may be in the same vibration direction as the air conduction sound generation unit so that the sound waves generated by the piezoelectric sound generation unit 620 and the sound waves generated by the air conduction sound generation unit do not cancel each other as much as possible. Thus, the output capability and output effect of the air conduction acoustic wave are improved. In some embodiments, the vibration direction of the piezoelectric sound generation unit 620 may be approximately the same as the vibration direction of the air conduction sound generation unit 630. In some embodiments, the included angle between the vibration direction of the piezoelectric sound generation unit 620 and the vibration direction of the air conduction sound generation unit 630 may be within a range of −20°-20°.

In some embodiments, the piezoelectric sound generation unit 620 and the air conduction sound generation unit 630 may also be placed in any other form, for example, the piezoelectric sound generation unit 620 and the air conduction sound generation unit 630 may be inclined.

In some embodiments, the acoustic output device 600 includes a housing 640, a bone conduction sound generation unit 610, a piezoelectric sound generation unit 620, and an air conduction sound generation unit 630. The air conduction sound generation unit 630 is mainly configured to output low-frequency air conduction sound waves, the bone conduction sound generation unit 610 is mainly configured to output medium-frequency bone conduction sound waves, and the piezoelectric sound generation unit 620 is mainly configured to output high-frequency bone conduction sound waves. The accommodation cavity of the housing 640 is divided into two independent chambers, with the bone conduction sound generation unit 610 and piezoelectric sound generation unit 620 placed in one chamber, and the air conduction sound generation unit 630 placed in another chamber, to prevent the vibration of the piezoelectric sound generation unit 620 and the bone conduction sound generation unit 610 from affecting the air conduction sound waves of the air conduction sound generation unit 630 through air transmission within the housing 640. Further description regarding the air conduction sound generation unit 630 may be found in FIG. 1, FIG. 6A, and FIG. 6B, and further description regarding the piezoelectric sound generation unit 620, the bone conduction sound generation unit 610, and the housing 640 may be found in FIG. 1, FIG. 3A, and FIG. 3B.

In some embodiments, to avoid the vibration of the bone conduction sound generation unit 610 and the vibration of the air conduction sound generation unit interacting with each other through vibration transmission of the housing 640, the vibration direction of the diaphragm may be perpendicular to the vibration direction of the bone conduction sound generation unit 610. In some embodiments, the piezoelectric sound generation unit 620 vibrates to generate bone conduction acoustic waves, and the vibration direction of the piezoelectric sound generation unit 620 may be consistent with the vibration direction of the bone conduction sound generation unit 610 so that the sound waves generated by the piezoelectric sound generation unit 620 and the sound waves generated by the bone conduction sound generation unit 610 do not cancel each other as much as possible, thereby improving the output capability and output effect of the bone conduction acoustic waves.

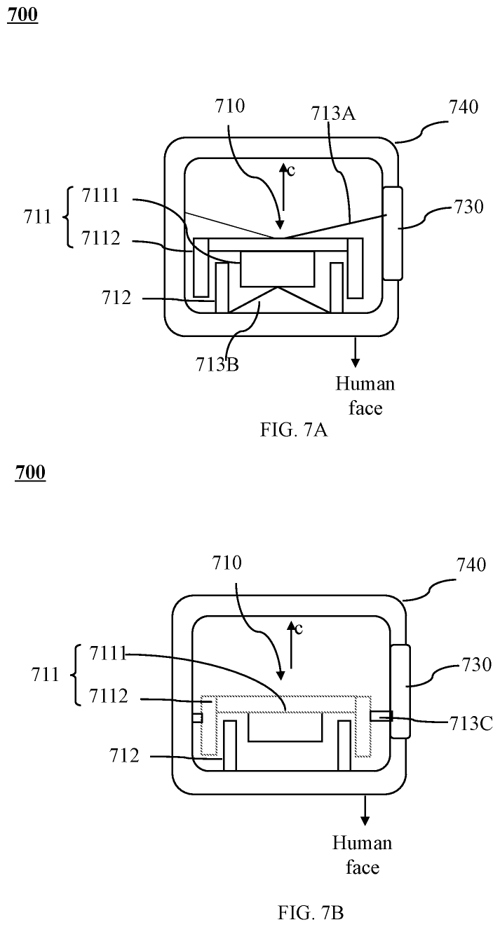

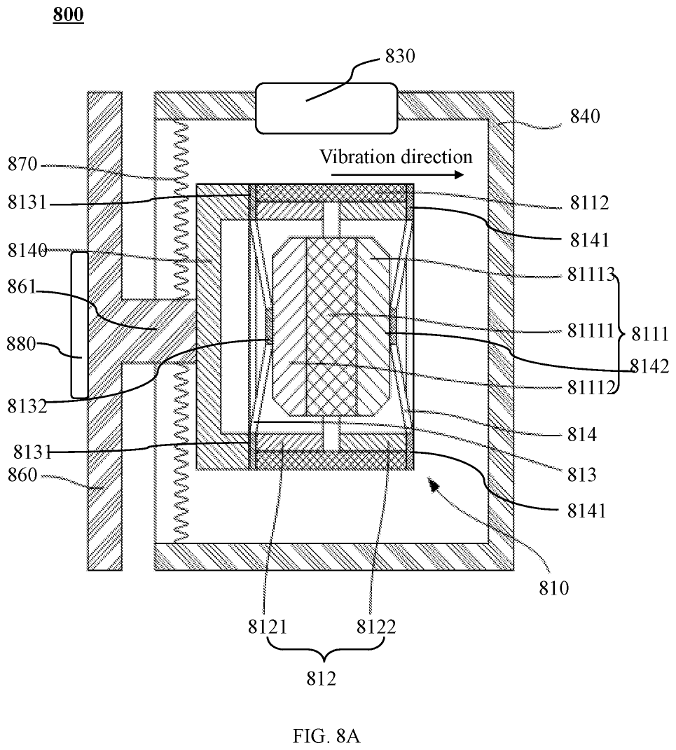

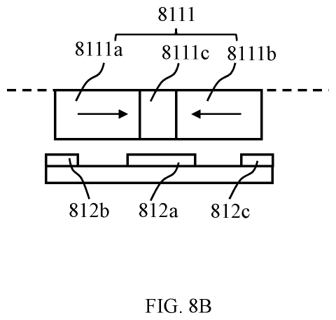

Various embodiments of the bone conduction sound generation unit may be described hereinafter in connection with FIG. 7A-FIG. 8A.

FIG. 7A and FIG. 7B are schematic diagrams illustrating an exemplary structure of an acoustic output device according to some embodiments of the present disclosure. As shown in FIG. 7A and FIG. 7B, an acoustic output device 700 includes a housing 740, an air conduction sound generation unit 730, and a bone conduction sound generation unit 710. The housing 740 is similar to the housing 340A shown in FIG. 3A. The air conduction sound generation unit 730 is provided on a sidewall of the housing 740, the bone conduction sound generation unit 710 is provided in an accommodation cavity, and the vibration direction of the air conduction sound generation unit 730 is approximately perpendicular to the vibration direction of the bone conduction sound generation unit 710. Approximately perpendicular here refers to that an angle between a vibration direction of the air conduction sound generation unit 730 and a vibration direction of the bone conduction sound generation unit 710 may be within a specific range. In some embodiments, the specific range may be 70°-110°. Preferably, the specific range may be 80°-100°. In some embodiments, the diaphragm of the air conduction sound generation unit 730 may be disposed on a sidewall of the housing 740 that is adjacent to or away from a side of the housing 740 that contacts the human face. For example, an aperture is provided on the housing 740, and an edge of the diaphragm is connected to an aperture wall of the aperture. In this case, the diaphragm of the air conduction sound generation unit 730 may be considered as a portion of the sidewall of the housing 740, and the air conduction sound waves outputted by the air conduction sound generation unit 730 may be directly transmitted to the outside world. As another example, the diaphragm of the air conduction sound generation unit 730 may be disposed in an accommodation cavity of the housing 740, and correspondingly, the housing 740 may be provided with one or more sound guiding holes (not shown in the drawings), and the sound guiding holes may be configured to transmit air conduction sound waves generated by the air conduction sound generation unit 730 to the outside world. In some embodiments, the bone conduction sound generation unit 710 includes a magnetic circuit system 711, a coil 712, and a vibration transmission sheet 713A. The magnetic circuit system 711 includes a magnet assembly 7111 and a magnetic conductive cover 7112. The coil 712 is sleeved on an outer side of the magnet assembly 7111 around an axis parallel to the vibration direction (see the direction c shown in FIG. 7A) of the bone conduction sound generation unit 710. The magnetic conductive cover 7112 is arranged around the outer side of the coil 712 along the vibration direction of the bone conduction sound generation unit 710. The magnetic conductive cover 7112, the coil 712, and the magnet assembly 7111 are disposed spaced apart in a direction perpendicular to the vibration direction. A magnetic gap is formed between an inner sidewall of the magnetic conductive cover 7112 and the outer side of the magnet assembly 7111, and the vibration transmission sheet 713A elastically supports the magnet assembly 7111 from a side of the magnet assembly 7111 in the vibration direction. It is to be understood that the air conduction sound generation unit 730 may be replaced with a piezoelectric sound generation unit, and in this case, the position and structure, etc. of the piezoelectric sound generation unit in the acoustic output device 700 are similar to those of the piezoelectric sound generation unit 320A shown in FIG. 3A. Alternatively, the acoustic output device 700 may further include a piezoelectric sound generation unit, and the piezoelectric sound generation unit may be located on a sidewall of the housing 740 that contacts the human face (hereinafter referred to as a face-contact side), or on a sidewall of the housing 740 that is adjacent to or away from the face-contact side, or in the accommodation cavity of the housing 740. For more descriptions regarding the position and structure, etc., of the piezoelectric sound generation unit within the acoustic output device 700, reference may be made to the piezoelectric sound generation unit shown in FIG. 3B, FIG. 4, and FIG. 5.

In some embodiments, a side of the housing 740 that is connected to the bone conduction sound generation unit 710 may contact the user's facial region, and a vibration generated by the bone conduction sound generation unit 710 may be transmitted to the user through the housing 740. In some embodiments, the housing 740 may be connected to the magnet assembly 7111 via the vibration transmission sheet 713A to suspend the magnet assembly 7111 within the accommodation cavity of the housing 740. For example, the vibration transmission sheet 713A and the magnet assembly 7111 are arranged along the vibration direction, and a side surface of the vibration transmission sheet 713A that is perpendicular to the vibration direction is connected to an end portion of the magnetic conductive cover 7112 that is perpendicular to the vibration direction to fix the magnet assembly 7111. In some embodiments, the magnetic conductive cover 7112 may be connected to the magnet assembly 7111 to realize the fixation of the magnetic conductive cover 7112 with respect to the magnet assembly 7111. In some embodiments, the vibration transmission sheet 713A and the magnetic conductive cover 7112 are arranged along the vibration direction, and the side surface of the vibration transmission sheet 713A that is perpendicular to the vibration direction is connected to the end portion of the magnetic conductive cover 7112 that is perpendicular to the vibration direction. In some embodiments, the acoustic output device 700 may further include a vibration transmission sheet 713B, a side surface of the vibration transmission sheet 713B that is perpendicular to the vibration direction is connected to the end portion of the magnet assembly 7111 that is perpendicular to the vibration direction. The other side surface of the vibration transmission sheet 713B that is perpendicular to the vibration direction is connected to a sidewall of the housing 740 that is perpendicular to the vibration direction. It should be noted that only the vibration transmission sheet 713A or the vibration transmission sheet 713B, or both the vibration transmission sheet 713A and the vibration transmission sheet 713B, may be included in the acoustic output device 700 to further enhance the stability of the magnet assembly 7111 in vibration. In some embodiments, the vibration transmission sheet may be disposed between the magnetic conductive cover 7112 and the housing 740, as shown in FIG. 7B. A vibration transmission sheet 713C has an annular structure, and an inner ring side of the vibration transmission sheet 713C is connected to a peripheral side of the magnetic conductive cover 7112. An outer peripheral side of the vibration transmission sheet 713C is connected to the housing 740 to realize the fixation of the magnet assembly 7111 with respect to the magnetic conductive cover 7112.

In some embodiments, the magnetic conductive cover 7112 is a housing structure having an open end, and the magnet assembly 7111 is disposed within the magnetic conductive cover 7112. One end of the magnet assembly 7111 is connected to a bottom wall opposite to the open end of the magnetic conductive cover 7112, and a sidewall of the magnet assembly 7111 is spaced apart from the sidewall of the housing 740. In some embodiments, there is a distance between the inner wall of the magnetic conductive cover 7112 and the sidewall of the magnet assembly 7111 in a direction perpendicular to the vibration direction of the bone conduction sound generation unit 710 such that a magnetic gap is formed between the magnetic conductive cover 7112 and the peripheral side of the magnet assembly. One end of the coil 712 is connected to the face-contact side of the housing 740, the other end of the coil 712 extends into the magnetic gap, and there is a distance between the other end of the coil 712 and the magnetic conductive cover 7112 along the vibration direction to ensure a relative movement between the magnetic circuit system 711 and the coil 712.

FIG. 8A is a schematic diagram illustrating an exemplary structure of another acoustic output device according to some embodiments of the present disclosure. As shown in FIG. 8A, an acoustic output device 800 includes a housing 840, an air conduction sound generation unit 830, and a bone conduction sound generation unit 810. The air conduction sound generation unit 830 is similar to the air conduction sound generation unit 730 shown in FIG. 7A and may not be repeated herein. An accommodation cavity may be formed in the housing 840 for accommodating the bone conduction sound generation unit 810. The bone conduction sound generation unit 810 includes a magnetic circuit system, a coil 812, a first vibration transmission sheet 813, and a second vibration transmission sheet 814. The magnetic circuit system includes a magnet assembly 8111 and a magnetic conductive cover 8112. The coil 812 is sleeved on the outer side of the magnet assembly 8111 around an axis parallel to a vibration direction (see FIG. 8A) of the bone conduction sound generation unit 810, and the magnetic conductive cover 8112 is sleeved on the coil 812 along the vibration direction of the bone conduction sound generation unit 810. The magnetic conductive cover 8112 and the magnet assembly 8111 are spaced apart in a direction perpendicular to the vibration direction. A magnetic gap is formed between an inner sidewall of the magnetic conductive cover 8112 and the outer side of the magnet assembly 8111, and the first vibration transmission sheet 813 and the second vibration transmission sheet 814 elastically support the magnet assembly 8111 respectively from two opposite sides of the magnet assembly 8111 in the vibration direction. The magnet assembly 8111 in the embodiment of the present disclosure is elastically supported on the two opposite sides in the vibration direction of the bone conduction sound generation unit 810 such that the magnet assembly 8111 and the magnetic conductive cover 8112 can be prevented as much as possible from shaking due to mutual attraction or repulsion due to the magnetic force, which is conducive to increasing the vibration stability of the bone conduction sound generation unit 810. It is to be understood that the air conduction sound generation unit 830 may be replaced with a piezoelectric sound generation unit (e.g., the piezoelectric sound generation unit 420 shown in FIG. 4 or the piezoelectric sound generation unit 520 shown in FIG. 5). The piezoelectric sound generation unit may include a piezoelectric member and a diaphragm connected to the piezoelectric member. The vibration of the diaphragm driven by the piezoelectric member may generate air conduction sound waves. By adjusting the parameters (e.g., structure, length, width, thickness, material, etc.) of the piezoelectric member, the piezoelectric sound generation unit mainly outputs low-frequency air conduction sound waves similar to the air conduction sound generation unit 830. At this time, the position and the structure, etc., of the piezoelectric sound generation unit within the acoustic output device 800 are similar to the piezoelectric sound generation unit 320A shown in FIG. 3A. In the embodiment shown in FIG. 8A, the acoustic output device 800 further includes a piezoelectric sound generation unit 880, and the piezoelectric sound generation unit 880 is disposed on a vibration panel 860. The piezoelectric member generates a vibration under the action of the driving voltage, which may be transmitted to the human face together with the vibration of the vibration panel 860 and cause the user to hear the bone conduction sound waves through bone conduction. By adjusting the parameters (e.g., structure, length, width, thickness, material, etc.) of the piezoelectric member, the piezoelectric sound generation unit mainly outputs high-frequency bone conduction sound waves. In some embodiments, the piezoelectric sound generation unit 880 may be disposed on a sidewall of the housing 840 that is adjacent to or away from the vibration panel, or within an accommodation cavity of the housing 840. For more descriptions regarding the position and structure, etc., of the piezoelectric sound generation unit 880 within the acoustic output device 800, reference may be made to the piezoelectric sound generation units illustrated in FIG. 3B, FIG. 4, and FIG. 5. The air conduction sound generation unit 830 is mainly used for low-frequency (e.g., 20 Hz-500 Hz) output, the bone conduction sound generation unit 810 is mainly used for medium-frequency (e.g., 500 Hz-6 kHz) output, and the piezoelectric sound generation unit 880 is mainly used for high-frequency (e.g., 6 kHz-20 kHz) output, so that the sound output of the acoustic output device 800 may cover the range from low-frequency to high-frequency and the strength of sound output may be improved in the full frequency range, thereby effectively improving the overall sound quality.

In some embodiments, the acoustic output device 800 may include a vibration panel 860 connected to the bone conduction sound generation unit 810 and configured to transmit a mechanical vibration generated by the bone conduction sound generation unit 810 to the human face and act on the user's auditory nerves through the user's skin, bones, and/or tissues, thereby forming the bone conduction sound waves. It is to be appreciated that the housing 840 may have a cylindrical structure (e.g., a cuboid structure, a cylindrical structure), a sphere shape, a trapezoidal shape, etc., or any irregular shape, or any combination thereof, which is not limited to the shape shown in the drawings.

In some embodiments, the acoustic output device 800 may also include a dampening sheet 870. The bone conduction sound generation unit 810 may be suspended within the accommodation cavity of the housing 840 through the dampening sheet 870. The vibration panel 860 may not be in contact with the housing 840. In such cases, due to the dampening sheet 870, the mechanical vibration generated by the bone conduction sound generation unit 810 may be less, or even not transmitted to the housing 840, thus preventing the housing 840 from driving the air outside the acoustic output device 800 to vibrate, which is conducive to reducing a sound leakage of the acoustic output device 800. Furthermore, the vibration panel 860 and an element rigidly connected to the vibration panel 860 are elastically connected to the housing 840 and an element rigidly connected to the housing 840 via the dampening sheet 870, which may be approximated as a resonance system. In such cases, when additional elements (e.g., elements such as an air conduction sound generation unit, a piezoelectric sound generation element, a circuit element, a microphone, or the like) additionally disposed with respect to the bone conduction sound generation unit 810 are disposed in the housing 840, the vibration transmission between the additional elements and the vibration panel 860 may be suppressed in a specific frequency band (e.g., greater than a resonance frequency of the resonance system). That is, the influence of the additional elements on the vibration of the vibration panel 860 may be reduced, which ensures that the sensitivity of the bone conduction sound generation unit 810 in the acoustic output device 800 may not be affected by or less affected by the additional elements in the specific frequency band and the acoustic output device 800 has a better acoustic output effect in a larger frequency range, thereby improving the user's listening experience.

In some embodiments, the housing 840 may have an open end, and the vibration panel 860 is provided outside the housing 840 and faces the open end. That is, an edge of the vibration panel 860 is disconnected from the open end of the housing 840, and a connecting rod 861 is provided between the vibration panel 860 and the bone conduction sound generation unit 810. One end of the connecting rod 861 is connected to the bone conduction sound generation unit 81, and the other end of the connecting rod 861 penetrates out of the open end of the housing 840 and is connected to the vibration panel 860, so that the vibration panel 860 and the bone conduction sound generation unit 810 does not contact the housing 840, thereby reducing the sound leakage of the acoustic output device 800. In some embodiments, the dampening sheet 870 may be connected between the connecting rod 861 and the housing 840 to enable suspension of the vibration panel 860 and the bone conduction sound generation unit 810.

In some embodiments, the bone conduction sound generation unit 810 may include a bracket 8140, and the vibration panel 860 may be connected to the bracket 8140. In some embodiments, the bracket 8140 may be connected to an end of the connecting rod 861 that is away from the vibration panel 860, as shown in FIG. 8A. The bracket 8140 may be connected to the magnetic circuit system via the first vibration transmission plate 813 to suspend the magnetic circuit system within the accommodation cavity of the housing 840. In some embodiments, the dampening sheet 870 may connect the bracket 8140 and the housing 840 to suspend the bone conduction sound generation unit 810 within the accommodation cavity of the housing 840.

In some embodiments, the coil 812 may include a first coil 8121 and a second coil 8122. In some embodiments, the first coil 8121 may extend into a magnetic gap of the magnetic circuit system from a side proximate to the vibration panel 860 along the vibration direction, and the second coil 8122 may extend into the magnetic gap of the magnetic circuit system from a side away from the vibration panel 860 along the vibration direction. In some embodiments, to simplify the assembly process, the first coil 8121 and the second coil 8122 may extend together into the magnetic gap of the magnetic circuit system from the side proximate to the vibration panel 860. In some embodiments, the bone conduction sound generation unit 810 may further include a maintaining portion, and the maintaining portion is configured for keeping the first coil 8121 and the second coil 8122 in a fixed shape. For example, the first coil 8121 and the second coil 8122 may be of one-piece structure. Specifically, the first coil 8121 and the second coil 8122 may be wound on a shaping material, and the maintaining portion (e.g., a retaining material such as high-temperature tape) adheres to the exterior of the first coil 8121 and the second coil 8122 such that the first coil 8121 and the second coil 8122 form a one-piece structure. The first coil 8121 and the second coil 8122 fixed to the maintaining portion extend into the magnetic gap of the magnetic circuit system from the same side of the vibration panel 860, thus simplifying the process of assembling the coils. In some embodiments, the two coils are formed by the same metal wire or a section of the two coils is connected such that the two coils have only two leads for lead-in and lead-out, which can facilitate the wiring and subsequent electrical connection to other structures.

In some embodiments, in the vibration direction, opposite sides of an edge region 8131 of the first vibration transmission sheet 813 are connected to a side of the bracket 8140 that is close to the magnetic circuit system and a side of the magnetic conductive cover 8112 that is close to the bracket 8140, respectively. The edge region 8141 of the second vibration transmission sheet 814 is connected to a side of the magnetic conductive cover 8112 that is away from the bracket 8140. In some embodiments, the magnetic conductive cover 8112 may be a cylindrical structure with two open ends. In some embodiments, the magnetic conductive cover 8112 may be a closed structure such that the sound generated in the magnetic circuit system does not escape.

In some embodiments, the magnet assembly 8111 may include a magnet 81111, a first magnetic conductive plate 81112, and a second magnetic conductive plate 81113. The first magnetic conductive plate 81112 and the second magnetic conductive plate 81113 are provided on opposite sides of the magnet assembly 8111 in the vibration direction of the bone conduction sound generation unit 810. The first vibration transmission sheet 813 may support the magnet assembly 8111 from a side of the first magnetic conductive plate 81112 that is away from the second magnetic conductive plate 81113, and the second vibration transmission sheet 814 may support the magnet assembly 8111 from a side of the second magnetic conductive plate 81113 that is away from the first magnetic conductive plate 81112. In some embodiments, a center region 8132 of the first vibration transmission sheet 813 is connected to the side of the first magnetic conductive plate 81112 that is away from the second magnetic conductive plate 81113, and a center region 8142 of the second vibration transmission sheet 814 is connected to the side of the second magnetic conductive plate 81113 that is away from the first magnetic conductive plate 81112. In some embodiments, corners of the first magnetic conductive plate 81112 and/or the second magnetic conductive plate 81113 away from the magnet 81111 may be chamfered. For example, the corners of the first magnetic conductive plate 81112 and the second magnetic conductive plate 81113 on opposite sides (i.e., away from the magnets 81111) may be chamfered to adjust the distribution of the magnetic field formed by the magnetic circuit system so that the magnetic field is more concentrated. In some embodiments, in the vibration direction of the bone conduction sound generation unit 810, a half-height of the first coil 8121 and a half-thickness of a sideline of the first magnetic conductive plate 81112 that is parallel to the vibration direction may be equal, and a half-height of the second coil 8122 and a half-thickness of a sideline of the second magnetic conductive plate 81113 that is parallel to the vibration direction may be equal, so that the magnetic field may be centrally distributed in a rectangular portion other than a chamfered portion on the first magnetic conductive plate 81112 and/or the second magnetic conductive plate 81113.

In some embodiments, the magnetic conductive cover 8112 may be connected to the bracket 8140. The bracket 8140 may be connected to the housing 840 via the dampening sheet 870 to suspend the bone conduction sound generation unit 810 within the accommodation cavity of the housing 840. In such cases, two sides of the edge region 8131 of the first vibration transmission sheet 813 in the direction perpendicular to the vibration direction may be connected to the bracket 8140 and the magnetic conductive cover 8112, respectively. A side of the edge region 8141 of the second vibration transmission sheet 814 in the direction perpendicular to the vibration direction may be connected to the magnetic conductive cover 8112. The vibration panel 860 may be connected to the bracket 8140 and have a gap from the open end of the housing 840 to ensure that the vibration of the vibration panel 860 may not be affected by the housing 840. It is to be understood that, in some embodiments, the housing 840 and the vibration panel 860 may be connected through an elastic structure, such as an elastic silicone member, to realize the isolation of the housing 840 from the outside world, thereby realizing waterproofing, dustproofing, etc., while ensuring that the vibration of the vibration panel 860 is not affected.

As an alternative embodiment of the magnet assembly 8111, as shown in FIG. 8B, the magnet assembly 8111 may include a first magnet 8111a and a second magnet 8111b stacked along a vibration direction. Magnetization directions of the first magnet 8111a and the second magnet 8111b may be different. The first vibration transmission sheet 813 (illustrated in FIG. 8A) may support the magnet assembly 8111 from a side of the first magnet 8111a that is away from the second magnet 8111b, and the second vibration transmission sheet 814 (illustrated in FIG. 8A) may support the magnet assembly 8111 from a side of the second magnet 8111b that is away from the first magnet 8111a. In some embodiments, the center region 8132 of the first vibration transmission sheet 813 (illustrated in FIG. 8A) is connected to the side of the first magnet 8111a that is away from the second magnet 8111b, and the center region 8142 of the second vibration transmission sheet 814 (illustrated in FIG. 8A) is connected to the side of the second magnet 8111b that is away from the first magnet 8111a. In some embodiments, the magnet assembly 8111 may include a magnetic conductive plate 8111c sandwiched between the first magnet and the second magnet. In some embodiments, there may be one or three coils 812. When the count of the coil 812 is one, an orthographic projection of the coil (e.g., the first coil 812a) on a peripheral surface of the magnet assembly 8111 in a direction perpendicular to the vibration direction overlaps a side peripheral surface of the magnetic conductive plate 8111c. When there are three coils, for example, the coils may include a first coil 812a, a second coil 812b, or a third coil 812c spaced apart along the vibration direction, an orthographic projection of the first coil 812a on the peripheral surface of the magnet assembly 8111 in a direction perpendicular to the vibration direction overlaps the side peripheral surface of the magnetic conductive plate 8111c, an orthographic projection of the second coil 812b on the peripheral surface of the magnet assembly 8111 in a direction perpendicular to the vibration direction overlaps a side peripheral surface of the first magnet 8111a, and an orthographic projection of the third coil 812c on the peripheral surface of the magnet assembly 8111 in a direction perpendicular to the vibration direction overlaps a side peripheral surface of the second magnet 8111b. In some embodiments, the magnetization directions of the first magnet 8111a and the second magnet 8111b are opposite and are both perpendicular to a surface of the magnetic conductive plate 8111c that faces the first magnet 8111a or the second magnet 8111b.

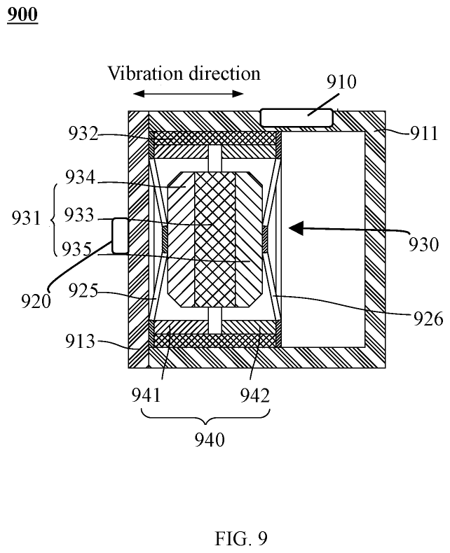

FIG. 9 is a schematic diagram illustrating an exemplary structure of yet another acoustic output device shown according to some embodiments of the present disclosure. As shown in FIG. 9, the acoustic output device 900 may include a housing 911, a vibration panel 913, and a bone conduction sound generation unit 930. In some embodiments, the housing 911 is a structure having an open end and a hollow interior, and the vibration panel 913 is disposed at the open end of the housing 911 and forms an accommodation cavity with the housing 911 that accommodates the bone conduction sound generation unit 930. In some embodiments, the bone conduction sound generation unit 930 may include a magnetic circuit system, a coil 940, a first vibration transmission sheet 925, and a second vibration transmission sheet 926. The magnetic circuit system may include a magnet assembly 931 and a magnetic conductive cover 932. The coil 940 is sleeved on the outer side of the magnet assembly 931 around an axis parallel to a vibration direction (see FIG. 9) of the bone conduction sound generation unit 930. The magnetic conductive cover 932 is sleeved on the coil 712 along the vibration direction of the bone conduction sound generation unit 930. The magnetic conductive cover 932 and the magnet assembly 931 are spaced apart in a direction perpendicular to the vibration direction. A magnetic gap is formed between an inner sidewall of the magnetic conductive cover 932 and the outer side of the magnet assembly 931. The first vibration transmission sheet 925 and the second vibration transmission sheet 926 elastically support the magnet assembly 931 from two opposite sides of the magnet assembly 931 in the vibration direction. In the embodiments of the present disclosure, the magnet assembly 931 is elastically supported on two opposite sides in the vibration direction of the bone conduction sound generation unit 930, so that there is no abnormal vibration such as obvious shaking, which is conducive to increasing the vibration stability of the bone conduction sound generation unit 930. In some embodiments, the coil 940 may include a first coil 941 and a second coil 942. The first coil 941 and the second coil 942 are disposed in the magnetic gap of the magnetic circuit system and are spaced apart in the vibration direction. Descriptions regarding the specific structure and position of the first coil 941 and the second coil 942 may be found in FIG. 8A and related descriptions thereof and may not be repeated here.

In some embodiments, the magnetic conductive cover 932 is rigidly connected to the housing 911 or the vibration panel 913, and a peripheral sidewall of the magnetic conductive cover 932 that is away from the magnet assembly 931 is affixed to an inner wall of the housing 911 to fully utilize the inner space the housing 911, which facilitates miniaturization of the acoustic output device. It may be appreciated that, in other embodiments of the present disclosure, the magnetic conductive cover 932 may also be rigidly connected to the housing 911 or the vibration panel 913 by other fixing structures. In some embodiments, an edge region of either of the first vibration transmission sheet 925 and the second vibration transmission sheet 926 may be connected to the open end of the housing 911 through one or a combination of assembling manners such as snapping, gluing, or the like, and the vibration panel 913 is connected to the open end of the housing 911 to form a closed cavity. In some embodiments, a side surface of either of the first vibration transmission sheet 925 and the second vibration transmission sheet 926 that is to the vibration panel 913 is connected to the vibration panel 913, and the vibration panel 913 is connected to the open end of the housing 911. In some embodiments, the vibration panel 913 may be of the same material as the housing 911 and integrally formed with the housing 911. In some embodiments, the vibration panel 913 may be of a different material from the housing 911 and is connected to the housing 911 through one of assembly manners such as snapping, gluing, or the like, or a combination thereof. In some embodiments, the magnet assembly 931 may include a magnet 933, a first magnetic conductive plate 934, and a second magnetic conductive plate 935. The first magnetic conductive plate 934 and the second magnetic conductive plate 935 are provided on opposite sides of the magnet 933 in the vibration direction of the bone conduction sound generation unit 930. The first vibration transmission sheet 925 may support the magnet assembly 931 from a side of the first magnetic conductive plate 934 that is away from the second magnetic conductive plate 935, and the second vibration transmission sheet 926 may support the magnet assembly 931 from a side of the second magnetic conductive plate 935 that is away from the first magnetic conductive plate 934. Detailed descriptions regarding the first vibration transmission sheet 925, the second vibration transmission sheet 926, the first magnetic conductive plate 934, the second magnetic conductive plate 935, and the magnet 933 may be found in descriptions regarding the first vibration transmission sheet 813, the second vibration transmission sheet 814, the first magnetic conductive plate 81112, the second magnetic conductive plate 81113, and the magnet 81111 shown in FIG. 8A, and may not be repeated herein.

In some embodiments, the acoustic output device 900 may also include a piezoelectric sound generation unit 920 disposed on the vibrating panel 913. For example, the piezoelectric sound generation unit 920 may be disposed on a side of the vibration panel 913 that contacts the human face. As another example, the piezoelectric sound generation unit 920 may be located on a side of the vibration panel 913 that is away from the face-contact side. As yet another example, the piezoelectric sound generation unit 920 may be embedded in the vibration panel 913. In some embodiments, the piezoelectric sound generation unit 920 may also be disposed on a sidewall of the housing 911, for example, the piezoelectric sound generation unit 920 may be disposed on a sidewall of the housing 911 away from the vibration panel 913 or a sidewall of the housing 911 adjacent to the vibration panel 913. In some embodiments, the acoustic output device 900 may include an air conduction sound generation unit 910 disposed on a side of the sidewall of the housing 911 that is away from the accommodation cavity, where air conduction sound waves emitted by the air conduction sound generation unit 910 may be directly transmitted to the outside world. In some embodiments, the air conduction sound generation unit 910 may also be disposed on the inner side of the sidewall of the housing 911, or in the accommodation cavity of the housing 911 and be fixedly connected with the housing 911 through a fixing member. Furthermore, sound guiding holes (not shown in the drawings) are provided on the housing 911, where the air conduction sound waves outputted from the air conduction sound generation unit 910 may be transmitted via the sound guiding holes to the outside world. Detail descriptions regarding the piezoelectric sound generation unit 920 and the air conduction sound generation unit 910 may be found in FIG. 1-FIG. 5 of the present disclosure. The air conduction sound generation unit 910 is mainly used for low-frequency (e.g., 20 Hz-500 Hz) output, the bone conduction sound generation unit 930 is mainly used for medium-frequency (e.g., 500 Hz-6 kHz) output, and the piezoelectric sound generation unit 920 is mainly used for high-frequency (e.g., 6 kHz-20 kHz) output, so that the sound output of the acoustic output device 900 may cover the range from low frequency to high frequency and the strength of sound output may be improved in the full frequency range, thereby effectively improving the overall sound quality.

It is noted that FIG. 1-FIG. 9 are used for exemplary descriptions only and do not constitute limitations thereon. For a person of ordinary skill in the art, a variety of variations and modifications can be made according to the guidance of the present disclosure. Different embodiments may produce different beneficial effects, and in different embodiments, the beneficial effects that may be produced may be any one or a combination of any of the above, or any other beneficial effect that may be obtained.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and amendments are intended to be suggested by this disclosure and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment”, “one embodiment”, or “an alternative embodiment” in various portions of the present disclosure are not necessarily all referring to the same embodiment. In addition, some features, structures, or characteristics of one or more embodiments in the present disclosure may be properly combined.

Furthermore, the recited order of processing elements or sequences, or the use of numbers, letters, or other designations, therefore, is not intended to limit the claimed processes and methods to any order except as may be specified in the claims. Although the above disclosure discusses some embodiments of the invention currently considered useful by various examples, it should be understood that such details are for illustrative purposes only, and the additional claims are not limited to the disclosed embodiments. Instead, the claims are intended to cover all combinations of corrections and equivalents consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about”, “approximate”, or “substantially”. For example, “about”, “approximate”, or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes. History application documents that are inconsistent or conflictive with the contents of the present disclosure are excluded, as well as documents (currently or subsequently appended to the present specification) limiting the broadest scope of the claims of the present disclosure. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. An acoustic output device, comprising:
a bone conduction sound generation unit configured to generate bone conduction sound waves that are transmitted to human ears via bone and have at least one resonance peak in a frequency range not higher than 1 kHz;
a piezoelectric sound generation unit configured to generate sound waves that have at least one resonance peak in a range not lower than 6 kHz; and
an air conduction sound generation unit configured to generate air conduction sound waves having a resonance peak in a frequency range of no higher than 500 Hz.

2. The acoustic output device of claim 1, wherein the piezoelectric sound generation unit is provided on a sidewall of a housing of the acoustic output device that contacts a human face,
the piezoelectric sound generation unit generates second bone conduction sound waves and transmits the second bone conduction sound waves to the human face.

3. The acoustic output device of claim 1, wherein the piezoelectric sound generation unit includes a piezoelectric member and a vibrating plate connected to the piezoelectric member,
the vibrating plate is fixed to the sidewall contacting the human face, and
the piezoelectric member vibrates to cause the vibrating plate to vibrate to generate second bone conduction sound waves.

4. The acoustic output device of claim 1, wherein the piezoelectric sound generation unit is placed in a position where the housing of the acoustic output device does not contact a human face,
mechanical vibrations generated by the piezoelectric sound generation unit are transmitted to the housing,
the piezoelectric sound generation unit or the housing generates sound waves.

5. The acoustic output device of claim 1, wherein the piezoelectric sound generation unit includes a piezoelectric member and a diaphragm connected to the piezoelectric member,
the piezoelectric member drives the diaphragm to vibrate to generate second air conduction sound waves, and
the diaphragm is perpendicular to a vibration direction of the bone conduction sound generation unit.

6. The acoustic output device of claim 1, wherein the air conduction sound generation unit includes a diaphragm, and
a vibration direction of the diaphragm of the air conduction sound generation unit is perpendicular to the vibration direction of the bone conduction sound generation unit.

7. The acoustic output device of claim 1, wherein the piezoelectric sound generation unit vibrates to generate second air conduction sound waves,
the piezoelectric sound generation unit is placed in a stack or side by side with the air conduction sound generation unit, and
a vibration direction of the air conduction sound generation unit is perpendicular to the vibration direction of the bone conduction sound generation unit.

8. The acoustic output device of claim 1, wherein the piezoelectric sound generation unit includes a piezoelectric member, and
the bone conduction sound generation unit and the piezoelectric member vibrate driven by the same excitation voltage.

9. The acoustic output device of claim 8, wherein the piezoelectric sound generation unit has at least one resonance peak when a resonance frequency of the piezoelectric sound generation unit is in a range of no lower than 8 kHz.

10. The acoustic output device of claim 8, wherein the acoustic output device further includes a boost circuit, and
the boost circuit boosts the excitation voltage driving the piezoelectric member.

11. The acoustic output device of claim 10, wherein the piezoelectric sound generation unit has at least one resonance peak when a resonance frequency of the piezoelectric sound generation unit is in a range of no lower than 7 kHz.

12. The acoustic output device of claim 1, further comprising a frequency divider circuit, wherein
the frequency divider circuit divides a frequency based on a first frequency division point to generate a first frequency range signal and a second frequency range signal,
the first frequency range signal is configured to drive the bone conduction sound generation unit, and
the second frequency range signal is configured to drive the piezoelectric sound generation unit.

13. The acoustic output device of claim 12, further comprising a boosting circuit, wherein the boosting circuit is configured to boost the second frequency range signal.

14. The acoustic output device of claim 12, wherein
the frequency divider circuit divides the first frequency range signal based on a second frequency division point to generate a first sub-frequency range signal and a second sub-frequency range signal,
the first sub-frequency range signal is configured to drive the air conduction sound generation unit,
the second sub-frequency range signal is configured to drive the bone conduction sound generation unit, and
the second frequency division point is smaller than the first frequency division point.

15. The acoustic output device of claim 1, wherein the bone conduction sound generation unit comprises a magnetic circuit system, a coil, and a vibration transmission sheet, wherein
the magnetic circuit system is elastically connected to the housing of the acoustic output device through the vibration transmission sheet; and
the magnetic circuit system includes a magnet assembly and a magnetic conductive cover, the magnetic conductive cover is a housing structure having an open aperture at one end, the magnet assembly is located in the magnetic conductive cover in a direction perpendicular to a vibration direction of the bone conduction sound generation unit, an interval between the magnetic conductive cover and the magnet assembly forms a magnetic gap of the magnetic circuit system, and the coil extends into the magnetic gap from the open aperture of the magnetic conductive cover.

16. The acoustic output device of claim 1, wherein the bone conduction sound generation unit comprises a magnetic circuit system, a coil, and a vibration transmission sheet, wherein
the magnetic circuit system includes a magnet assembly,
the coil is wound around an outer side of the magnet assembly in an axis parallel to the vibration direction of the bone conduction sound generation unit, and the vibration transmission sheet elastically supports the magnet assembly from a side of the magnet assembly in a vibration direction of the bone conduction sound generation unit.

17. The acoustic output device of claim 1, wherein the bone conduction sound generation unit includes a magnetic circuit system, a coil, a first vibration transmission sheet, and a second vibration transmission sheet, wherein
the coil is wound around an axis parallel to the vibration direction of the bone conduction sound generation unit on an outer side of the magnet assembly, and the first vibration transmission sheet and the second vibration transmission sheet elastically support the magnet assembly from opposite sides of the magnet assembly in a vibration direction of the bone conduction sound generation unit, respectively.

18. The acoustic output device of claim 17, wherein the magnetic circuit system further includes a magnetic conductive cover, the magnet assembly includes a magnet, and a first magnetic conductive plate and a second magnetic conductive plate provided on opposite sides of the magnet assembly in the vibration direction of the bone conduction sound generation unit, wherein
the coil is wound around an axis parallel to the vibration direction of the bone conduction sound generation unit on outer side of the magnet assembly, the first vibration transmission sheet elastically supports the magnet assembly from a side of the first magnetic conductive plate back away from the second magnetic conductive plate, and the second vibration transmission sheet elastically supports the magnet assembly from a side of the second magnetic conductive plate back away from the first magnetic conductive plate;
the magnetic conductive cover is wound around the axis on an outer side of the coil; and
an edge region of the first vibration transmission plate is connected to one end of the magnetic conductive cover, and an edge region of the second vibration transmission plate is connected to another end of the magnetic conductive cover.

19. The acoustic output device of claim 17, wherein the magnet assembly includes a first magnet and a second magnet disposed in cascade along the vibration direction of the bone conduction sound generation unit,
magnetized directions of the first magnet and the second magnet are different,
a center region of the first vibration transmission sheet is connected to a side of the first magnet back from the second magnet, and
a center region of the second vibration transmission sheet is connected to a side of the second magnet back from the first magnet.

20. The acoustic output device of claim 19, wherein the magnet assembly further includes a magnetic conductive plate interposed between the first magnet and the second magnet,
the coil overlaps a side peripheral surface of the magnetic conductive plate when the coil is projected orthogonally to a peripheral surface of the magnet assembly in a direction perpendicular to the vibration direction of the bone conduction sound generation unit.
